(19) United States
(12) Patent Application Publication
(10) Pub. No.: US 2009/0065705 A1
(43) Pub. Date: Mar. 12, 2009

(54) SCINTILLATOR PLATE

(76) Inventors: Manfred Fuchs, Nurnberg (DE); Debora Henseler, Erlangen (DE); Georg Wittmann, Herzogenaurach (DE)

Correspondence Address: SCHIFF HARDIN, LLP;PATENT DEPARTMENT, 6600 SEARS TOWER, CHICAGO, IL, 60606-6473, US

(21) Appl. No.: 12/298,973

(22) PCT Filed: Apr. 12, 2007
(86) PCT No.: PCT/EP2007/053561

§ 371 Date: Oct. 29, 2008

(30) Foreign Application Priority Data
May 11, 2006 (DE) 10 2006 022 138.9

(51) Int. Cl. G01T 1/20

(52) U.S. Cl. 250/370.11

(57) ABSTRACT

A scintillator plate has a radiation permeable and moisture-impermeable substrate, a scintillator on the substrate, a first transparent organic layer that covers the scintillator, a second transparent organic layer arranged on the first transparent organic layer, and a transparent inorganic layer that is arranged on the second transparent organic layer.

### BACKGROUND OF THE INVENTION

1. Field of the Invention

The invention concerns a scintillator plate.

2. Description of the Prior Art

Such a scintillator plate is used in a digital x-ray detector (flat image detector, flat panel detector) in combination with an active matrix that is subdivided into a plurality of pixel readout units with photodiodes. The incident x-ray radiation is initially converted in the scintillator of the scintillator plate into visible light that is transduced by the photodiodes into electrical charge and is stored with spatial resolution. This conversion (what is known as an indirect conversion) is described in the article by M. Spahn et al., “Flachbilddetektoren in der Röntgendiagnostik” in “Der Radiologe 43 (2003)”, Pages 340 through 350, for example.

Typical scintillators consist of Csl:Tl, Cdl:Na, Nal:Tl or similar materials that contain alkali halogenides, wherein Csl is particularly well suited as a scintillator material since it can be grown in needles. In spite of a high layer thickness that ensures an optical absorption of the x-ray radiation, a good spatial resolution of the x-ray image is thereby obtained. The good spatial resolution results from what is known as the “light guide effect” that is achieved due to the air gaps between the Csl needles.

Due to their content of alkali halogenides, the scintillator materials are at least slightly hygroscopic and must be sufficiently protected from harmful environmental influences (humidity, excessive temperature). For example, the Csl needles can “flow into one another” under the influence of temperature, humidity and air. The important parameter “air gap” is at least significantly reduced. As a result of this, the spatial resolution is reduced. At the same time, given use of a metallic substrate or of a metallic mirror the penetrating moisture can lead to corrosion of said substrate.

In order to protect the scintillator material from external environmental influences, the scintillator plate must be hermetically encapsulated. For this purpose, in U.S. Pat. No. 6,429,430 B2 two to three transparent slices are applied on a scintillator that is applied on a radiation-permeable substrate and is advantageously produced from Csl doped with Tl. An organic layer made of parylene is initially applied on the scintillator in a CVD method (CVD—chemical vapor deposition; chemical gas phase deposition). An inorganic layer (for example of Al₂O₃ or SiO₂) is then arranged on the parylene layer. If necessary, the inorganic layer is coated with an additional organic layer of parylene.

In the scintillator plate according to U.S. Pat. No. 6,429,430 B2, the inorganic layer made of Al₂O₃ or SiO₂ which ensures the hermetic sealing (encapsulation) is applied directly on the parylene layer. This is difficult from a production standpoint since the inorganic layer adheres poorly to the parylene layer, and therefore the surface of the parylene layer must be subjected to an elaborate plasma treatment before the coating with the inorganic layer of Al₂O₃ or SiO₂ in order to be able to apply the inorganic layer immediately following. As an alternative to the complicated plasma treatment, the inorganic layer can also be applied on the parylene layer as long as the surface of the parylene layer is not in an active state, thus before the polymerization has concluded. However, in its active state the surface of the parylene layer is profoundly dust-attracting, whereby the barrier effect of the applied inorganic layer and the possibly applied additional parylene layer weakens.

From EP 1 389 783 A2, a scintillator plate is known with a substrate on which a scintillator is applied. In the known scintillator plate, a coated foil is affixed on the scintillator over the entire surface or at least in a border area as a protective layer. The coated foil is executed as a smooth support foil made of PET and possesses an inorganic barrier layer of aluminum oxide. The support foil merely has the function to support the inorganic barrier layer. Due to the layer thickness of the support foil of at least 12 μm, the spatial resolution is relatively poor. Moreover, an interfering bubble formation can occur in the adhesion or lamination method required for the application of the protecting layer. Furthermore, an edge sealing is required that can be complicated to execute from a production standpoint and that requires a relatively large area, so the active scintillator surface is corresponding reduced.

### SUMMARY OF THE INVENTION

An object of the present invention is to provide a scintillator plate that has an improved protection from environmental influences (in particular from moisture) and that, relative to the known scintillator plates, requires a lesser technical effort for manufacture.

The above object is achieved in accordance with the present invention by a scintillator plate having a radiation-permeable and moisture-impermeable substrate, a scintillator applied on the substrate, a first, transparent, organic layer that covers the scintillator, a second, transparent, organic layer that is arranged on the first transparent, organic layer, and a transparent, inorganic layer that is arranged on the second transparent, organic layer.

In the scintillator plate according to the invention, the transparent inorganic layer that essentially determines the efficiency of the encapsulation is not arranged directly on the first transparent organic layer. Rather, according to the invention a second transparent organic layer is applied on the first transparent organic layer. In the solution according to the invention, the first transparent organic layer essentially has the function of coating the needles of the scintillator. A good anchoring of the protective layer bond is thereby achieved. The second transparent organic layer alone, whose essential function is the planarization, produces—together with the transparent inorganic layer applied on it—an excellent barrier against the environment influences (in particular moisture) harmful to the scintillator. Furthermore, the solution according to the invention offers a very good encapsulation against oxygen and other gases. Even sensitive materials (for example silver) can therefore be used as a substrate for the scintillator in the scintillator plate according to the invention. The coupling of the scintillator plate to a “gas-sensitive” photodiode matrix (for example organic matrix with Ca cathode) is also possible without detrimentally affecting the lifespan of the scintillator (and therefore of the scintillator plate).

In an embodiment for the encapsulation of the scintillator plate according to the invention a fourth transparent organic layer t is arranged on the transparent inorganic layer.

The hermetic encapsulation of the scintillator plate according to the invention is also improved, according to another embodiment by a third transparent organic layer that is arranged on the transparent inorganic layer. The fourth transparent organic layer can be applied on the third transparent organic layer for specific application cases.

According to a further preferred embodiment of the scintillator plate a transparent organic intermediate layer is arranged between the substrate and the scintillator.

A good encapsulation of the scintillator plate is achieved according to a further embodiment wherein the first transparent organic layer covers the substrate and the scintillator. This encapsulation is again improved when the first transparent organic layer covers the substrate and the scintillator and encloses the substrate in its edge region.

The scintillator plate according to another embodiment has a fourth transparent organic layer that encloses the substrate in its edge region.

In a further preferred embodiment of the scintillator plate the first transparent organic layer and/or the second transparent organic layer has a flat edge angle (advantageously of 30°) in the edge region of the substrate. The inorganic layer can enclose the edges of the substrate in a permeation-tight manner.

Advantageous materials for the transparent organic layers as well as for the transparent inorganic layer are as follows.

Parylene is a completely linear, semi-crystalline and un-crosslinked polymer group that enables a geometry-conforming coating without air inclusions.

Parylene and in particular parylene C possess one of the lowest permeation rates for water vapor with regard to organic layers. In particular parylene C (cloro-poly-para-xylylene) is therefore the variant most used for coatings of scintillators. Parylene C leads to a good combination of mechanical and electrical properties, as well as a very low permeability relative to moisture and corrosive gases.

### BRIEF DESCRIPTION OF THE DRAWINGS

FIG. 1 is a cross-section through a first embodiment of a scintillator plate in accordance with the present invention.

FIG. 2 is a cross-section through a second embodiment of a scintillator plate in accordance with the present invention.

### DESCRIPTION OF THE PREFERRED EMBODIMENTS

Two exemplary embodiments of the scintillator plate according to the invention are explained below, without limitation to these exemplary embodiments.

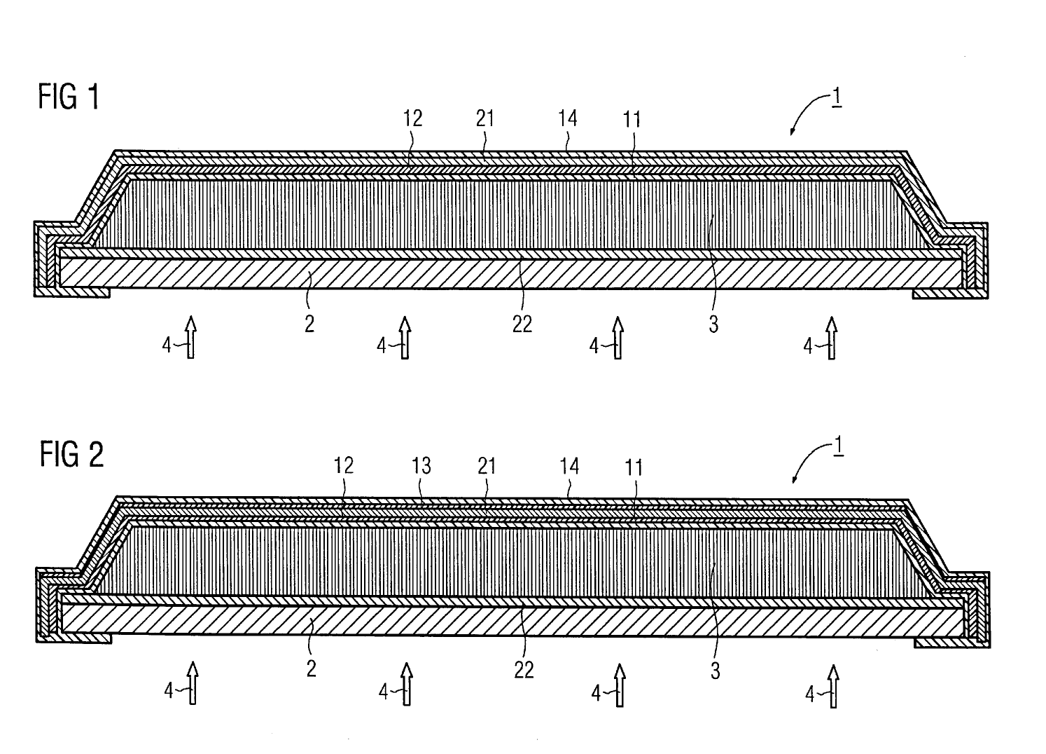

In FIGS. 1 and 2, a scintillator plate 1 with has a substrate 2. The substrate 2 is produced from a radiation-permeable and moisture-impermeable material. A scintillator 3 with a layer thickness of approximately 50 μm to approximately 600 μm is applied (vacuum deposited) in a known manner on the substrate 2 (which has a layer thickness of approximately 300 μm to approximately 700 μm, for example).

In FIGS. 1 and 2, an x-ray beam that passes through the substrate 2 and generates visible light in the scintillator 3 is designated with 4. The visible light exiting from the scintillator 2 is transduced into electrical charge in a photosensor (not shown) that consists of a plurality of photodiodes and is stored with spatial resolution (what is known as indirect conversion).

In the shown exemplary embodiments of the scintillator plate 1 according to the invention, the substrate 2 can have the following design, described in the periodical “iew Elektrowärme International 53 (1995) B 4 Nov.), Pages 215 through 223:

An Al₂O₃ layer with a layer thickness of approximately 1 μm to approximately 3 μm is applied on a band made of highest-grade aluminum with a layer thickness of approximately 300 μm to approximately 700 μm via an anodizing process. A highly reflective, highest-grade aluminum layer of approximately 80 nm in thickness is deposited on this anodized layer. To increase reflection, a low-refraction oxide layer (SiO₂) with a layer thickness of approximately 88 nm and a high-refraction oxide layer (TiO₂) of approximately 55 nm, both of which satisfy the λ/4 condition, are furthermore deposited, such that total reflections in the range of 95% are achievable.

The effect of a substrate on the image quality of the slices is already described in DE 103 01 284 A1 in the example of memory luminophore.

In this context it is inherently understood that the substrate 2 in the framework of the invention can also exhibit a different design (for example only one layer), and/or can consist of different materials.

In the scintillator plate 1 shown in FIGS. 1 and 2, the scintillator 3 is covered by a first transparent organic layer 11 with a layer thickness of approximately 0.5 μm to approximately 20 μm that advantageously consists of parylene. Furthermore, a second transparent organic layer 12 that has a layer thickness of approximately 2 μm to approximately 20 μm and that advantageously consists of epoxy resin is arranged on the first transparent organic layer 11. Finally, a transparent inorganic layer 21 that has a layer thickness of approximately 20 nm to approximately 500 nm and that, for example, consists of Al₂O₃, SiO₂ or Si₃N₄ is arranged on the second transparent organic layer 12.

Due to the combination of the materials epoxy resin and Al₂O₃, a good seed growth is obtained with close seed boundaries of Al₂O₃ on the epoxy resin, whereby a lower permeation rate is ensured.

In the embodiment of the scintillator plate 1 according to the invention that is shown in FIG. 2, a third transparent organic layer 13 with a layer thickness of approximately 2 μm to approximately 10 μm that advantageously is formed of parylene or epoxy resin is applied on the first transparent inorganic layer 21.

In the embodiment of the scintillator plate 1 according to the invention that is presented in FIG. 1, a fourth transparent organic layer 14 as an outermost layer is arranged on the transparent inorganic layer 21. The fourth transparent organic layer 14, whose layer thickness is approximately 2 μm to approximately 10 μm, also advantageously is formed of parylene.

In the exemplary embodiment of the scintillator plate 1 according to the invention that is shown in FIG. 2, a fourth transparent organic layer 14 is arranged on the third transparent organic layer 13. The fourth transparent organic layer 14, which in turn advantageously consists of parylene, therefore also forms the outermost layer in the scintillator plate 1 according to FIG. 2.

In the scintillator plates 1 presented in FIGS. 1 and 2, a transparent organic intermediate layer 22 (advantageously made of parylene or epoxy resin) is respectively arranged between the substrate 2 and the scintillator 3. The layer thickness of the organic intermediate layer 22 is approximately 0.5 μm to approximately 20 μm.

Due to the organic intermediate layer 22, the substrate 2 can be reliably protected from a corrosion that can occur given a mirror effect of the substrate 2 that disrupted at points (caused by dust inclusion).

A good encapsulation is achieved in the scintillator plate 1 according to FIGS. 1 and 2 in that the first transparent organic layer 11 covers the substrate 2 and the scintillator 3 and the fourth transparent organic layer 14 encloses the substrate 2 in its edge region

Although modifications and changes may be suggested by those skilled in the art, it is the intention of the inventors to embody within the patent warranted heron all changes and modifications as reasonably and properly come within the scope of their contribution to the art.

1. Scintillator plate comprising:
a radiation-permeable and moisture-impermeable substrate;
a scintillator applied on the substrate;
a first transparent organic layer that covers the scintillator;
a second transparent organic layer that is arranged on the first transparent organic layer;
a transparent inorganic layer that is arranged on the second transparent organic layer.

2. Scintillator plate according to claim 1, comprising:
a third transparent organic layer arranged on the transparent inorganic layer.

3. Scintillator plate according to claim 1, comprising a fourth transparent organic layer is arranged on the transparent inorganic layer.

4. Scintillator plate according to claim 2, comprising a fourth transparent organic layer arranged on the third transparent organic layer.

5. Scintillator plate according to claim 1, comprising a transparent organic intermediate layer arranged between the substrate and the scintillator.

6. Scintillator plate according to claim 1, wherein the first transparent organic layer covers the substrate and the scintillator.

7. Scintillator plate according to claim 1, wherein
the first transparent organic layer covers the substrate and the scintillator and encloses an edge region of the substrate.

8. Scintillator plate according to claim 3, wherein
the fourth transparent organic layer encloses an edge region of the substrate.

9. Scintillator plate according to claim 1, wherein
the first transparent organic layer and/or the second transparent organic layer has a flat edge angle at-an edge region of the substrate.

10. Scintillator plate according to claim 9, wherein
the inorganic layer encloses edges of the substrate in a permeation-tight manner.

11. Scintillator plate according to claim 1, wherein
the first transparent organic layer consists of parylene.

12. Scintillator plate according to claim 1, wherein
the second transparent organic layer consists of epoxy resin.

13. Scintillator plate according to claim 1, wherein
the transparent inorganic layer consists of an aluminum oxide or a silicon oxide.

14. Scintillator plate according to claim 2, wherein
the third transparent organic layer consists of epoxy resin.

15. Scintillator plate according to claim 3, wherein
the fourth transparent organic layer consists of parylene.

16. Scintillator plate according to claim 1, wherein the substrate has a high degree of reflection for light in the visible range.

17. Scintillator plate according to claim 9, wherein said edge angle is 30°.

18. Scintillator plate according to claim 4 wherein said fourth transparent organic layer encloses an edge region of the substrate.
